(19) United States
(12) Patent Application Publication
(10) Pub. No.: US 2024/0110640 A1
(43) Pub. Date: Apr. 4, 2024

(54) ELECTRICAL CABLE HANGERS

(71) Applicant: Hubbell Incorporated, Shelton, CT (US)

(72) Inventors: Evan Ronald Martin, Litchfield, NH (US); Greg Patrick Roccapriore, Bath, NH (US)

(21) Appl. No.: 18/371,115

(22) Filed: Sep. 21, 2023

Related U.S. Application Data
(60) Provisional application No. 63/412,411, filed on Oct. 1, 2022.
(60) Provisional application No. 63/433,809, filed on Dec. 20, 2022.

(51) Int. Cl. F16L 3/06; F16L 3/24; H02G 3/04

(52) U.S. Cl. CPC F16L 3/06; F16L 3/24; H02G 3/0456

(57) ABSTRACT

A hanger for securing electrical cabling to a structure, the hanger including a cable holding portion provided at a distal end of the hanger for holding one or more cables to be secured, a hook-like portion provided at a proximal end portion of the hanger for securing to the structure and a locking clip-like portion provided intermediate of the cable holding portion and the hook-like portion for clipping the hanger to and securing the hanger to the structure.

### CROSS-REFERENCE TO RELATED APPLICATIONS

This application is based on and claims priority to U.S. Provisional Application Ser. No. 63/412,411 filed Oct. 1, 2022 entitled CABLE HANGER and U.S. Provisional Application Ser. No. 63/433,809 filed Dec. 20, 2022 entitled ELECTRICAL CABLE HANGERS the contents of each of which are incorporated herein in their entirety by reference.

### BACKGROUND

### Field

The present disclosure relates generally to hangers and more specifically, to electrical cable hangers.

### Description of the Related Art

Structures are often provided for supporting different types of systems which may include electrical systems, electrical components, cabling or wiring, etc. Often, electrical cabling or wiring is run to and from various parts of these systems utilizing one or more types of cable management systems.

For example, the use of photovoltaic arrays to provide electrical power in commercial, residential, and other environments has become more and more popular. Photovoltaic arrays are generally composed of a number of photovoltaic or solar modules and may be set within a support structure such as a metallic frame or rail system that supports the photovoltaic modules. The frame or rail system is attached to a structure such as a roof or the ground. When installing a photovoltaic array, a number of photovoltaic modules are assembled onto the frame or rail system. The metallic frames of the individual photovoltaic modules, and the structural pieces, e.g., the rails, on which the modules are mounted are generally made out of aluminum. Depending upon the size of the photovoltaic array, the rail system may include multiple metallic rails coupled or connected together in a grid-like pattern. To prevent shadowing on the solar panels, it is important that wires, electronic components, etc. remain away from the light receiving faces of the solar panels. This can be particularly difficult when solar panels which allow light to enter from the back and front (e.g., bi-facial installation) are utilized, since the cables and/or electrical components tend to hang or drape from the array, even when existing cable management systems are used. To ensure the integrity of cables running along the metal frames of the photovoltaic modules, the cables may be mounted to the metal frames using one or more of various types of wire management systems. The wire management systems provide neat, easy and efficient ways for connecting the cables to the support structure. Examples of cable management systems include various types of clips as well as various types of ties including twist ties, zip ties, hook and loop ties, crimped wire cable ties etc.

Maximizing energy production from photovoltaic arrays is important and is particularly important for utility-scale solar designers in order to provide a greater return on investment. One path to maximizing energy production involves the use of solar trackers which are used to expose the photovoltaic modules to more sun. Solar trackers when connected to the solar modules or arrays move the arrays to track the movement of the sun in the sky. In this way, the solar modules are always positioned to take optimum advantage for harvesting the sun's energy. Such solar trackers are often provided in between interconnected rows of solar modules which are themselves interconnected with one or more cables. The solar trackers generally require their own unique frames or support structures separate from those used to support the solar modules. These unique frames and support structures should also be capable of holding the cables from the interconnected solar modules as well as the cables used to power and control the solar trackers themselves, in a neat and efficient way. Because the solar trackers move the solar modules through various arcs and distances, the cables should be allowed some movement so as not to bind the system while still keeping the cables and wiring out of the way of moving parts to prevent pinching and out of the way of the solar modules to prevent shadowing.

Brackets or frames are used to support solar tracking units and, in particular, utility scale solar tracking units, often utilize various components including various types of brackets and are often provided in very specific configurations. An example of such a bracket or frame is depicted in FIG. 1 and is referred to herein generally as bracket or frame 10. Bracket 10 includes a generally V shaped frame portion 14 and a cross bolt or cross member 12 extending between end portions 20 of the V shaped frame 14. Cross bolt or cross member 12 may be secured on its ends to V-shaped frame 14 by end members 22. Bracket 10 may also include one or more inner supports 16, 18 providing added rigidity to the bracket 10.

While bracket 10 may provide a firm secure support for the solar tracking unit, cables from the solar tracking unit and/or solar modules may be left hanging and subject to pinching and/or result in shadowing of the solar modules.

Existing cable management systems are generally not particularly well suited for use on such a bracket 10. For example, existing clips for attaching a cable to a bracket are not suitable for supporting the weight of the relatively large number of cables passing by the solar tracking unit and will tend to slip off the bracket because of their weight and the movement of the bracket as the solar tracking unit tracks the movement of the sun. The various types of ties currently being utilized provide limited support for the cable and tend to slide up and down the portion of the bracket 10 to which they are attached as the bracket 10 moves, which may end up causing the cables to be worn through exposing and/or damaging the inner wires.

A need exists for hangers for securely and reliably hanging and holding electrical cables to various types of structures.

### SUMMARY

The present disclosure provides embodiments of electrical cable hangers for securing electrical components to structures.

According to an exemplary embodiment, a hanger for securing electrical cabling to a structure includes a cable holding portion provided at a distal end of the hanger for holding one or more cables to be secured, a hook-like portion provided at a proximal end portion of the hanger for securing to the structure and a locking clip-like portion provided intermediate of the cable holding portion and the hook-like portion for clipping the hanger to and securing the hanger to the structure.

According to another exemplary embodiment, an electrical cable hanger for securing a electrical cable to a structure includes a segment of wire including a proximal end and a distal end, a cable holding portion provided at the distal end of the segment of wire for holding one or more cables to be secured and at least one locking clip-like portion provided between the proximal end and the distal end of the segment of wire for clipping the hanger to and securing the hanger to the structure.

According to another exemplary embodiment, an electrical cable management system includes a segment of wire including a distal end portion configured as a cable carrier for holding one or more cables, a proximal end portion including a clip-like portion configured to clip onto a first portion of a frame and an intermediate portion comprising a clip-like portion configured to clip onto a second portion of the frame.

### BRIEF DESCRIPTION OF THE DRAWINGS

The figures depict embodiments for purposes of illustration only. One skilled in the art will readily recognize from the following description that alternative embodiments of the structures illustrated herein may be employed without departing from the principles described herein, wherein:

FIG. 1 is a perspective view of a frame to which embodiments of the present disclosure may be attached;

FIG. 2A is a perspective view of an electrical cable hanger for hanging cables according to an illustrative embodiment of the present disclosure alongside the frame depicted in FIG. 1 to which it can be attached;

FIGS. 2B and 2C are enlarged views of an electrical cable hanger according to an illustrative embodiment of the present disclosure for describing how the hanger is attached to a structure;

FIG. 3A is a view of an electrical cable hanger according to an illustrative embodiment of the present disclosure;

FIG. 3B-3D are enlarged perspective views of portions of an electrical cable hanger according to illustrative embodiments of the present disclosure;

FIG. 4 is a front view of an electrical cable hanger according to an illustrative embodiment of the present disclosure;

FIG. 5 is a side view of a portion of an electrical cable hanger according to another illustrative embodiment of the present disclosure;

FIG. 6 is side view of a portion of an electrical cable hanger according to other illustrative embodiments of the present disclosure;

FIG. 7 is a perspective view of an electrical cable hanger according to another illustrative embodiment of the present disclosure;

FIG. 8A-8D are views of the electrical cable hanger according to the illustrative embodiment of the present disclosure depicted in FIG. 7;

FIGS. 9A and 9B are views of the electrical cable hanger according to the illustrative embodiment of the present disclosure depicted in FIG. 7 for describing how the hanger is attached to a structure;

FIG. 10 is a perspective view of an electrical cable hanger according to an illustrative embodiment of the present disclosure;

FIG. 11 is a perspective view of an electrical cable hanger according to another illustrative embodiment of the present disclosure;

FIGS. 12A, 12B and 12C are views of the electrical cable hanger according to the illustrative embodiment of the present disclosure depicted in FIG. 11;

FIG. 13 is a side view of the electrical cable hanger according to the illustrative embodiment of the present disclosure depicted in FIG. 11;

FIGS. 14 and 15 are views of the electrical cable hanger according to the illustrative embodiment of the present disclosure depicted in FIG. 11 for describing how the hanger is attached to a structure; and

FIG. 16 is a perspective view of an electrical cable hanger according to another illustrative embodiment of the present disclosure.

### DETAILED DESCRIPTION

The present disclosure provides embodiments of electrical cable hangers or supports for securing electrical wires and cables to a structure. By way of examples only, embodiments of the present disclosure will be described as being attached to a support structure such as a metal frame or rail upon which a solar tracking unit may be mounted. For ease of description, the support structure may be referred to interchangeably herein as frame, bracket or rail. The wires or cables referred to herein as being supported may be formed by one or more solid conductors and/or by one or more stranded conductors.

Electrical cable hangers according to exemplary embodiments of the present disclosure will be described as being formed from a material capable of assuming a particular shape and substantially retaining that shape. The material may be referred to herein as wire or rod. A non-limiting example of such material is spring steel. The spring steel may be in the form of a wire or rod having a substantially circular cross-section, although other cross-sectional shapes are contemplated. Alternatively, the spring steel may be in be in the form of a strip or sheet having a substantially rectangular cross-section. The wire selected may include round galvanized steel, round stainless steel, flat rolled galvanized steel, flat rolled stainless steel, etc. The spring steel may be coated with a suitable material to protect it from the environment. For example, the spring steel may be galvanized. Alternatively, other forms of environmentally protected materials such as stainless spring steel may be utilized. One or more portions of the material may be provided with a coating which is non-conductive and/or provides a higher coefficient of friction than the material itself. The gauge of the material is selected to be suitable for the size and/or number of cables to be held and generally may range between 6-18 gauge.

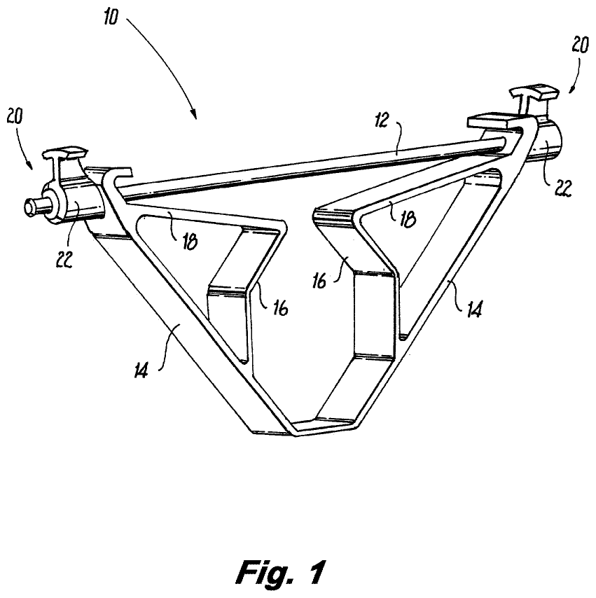

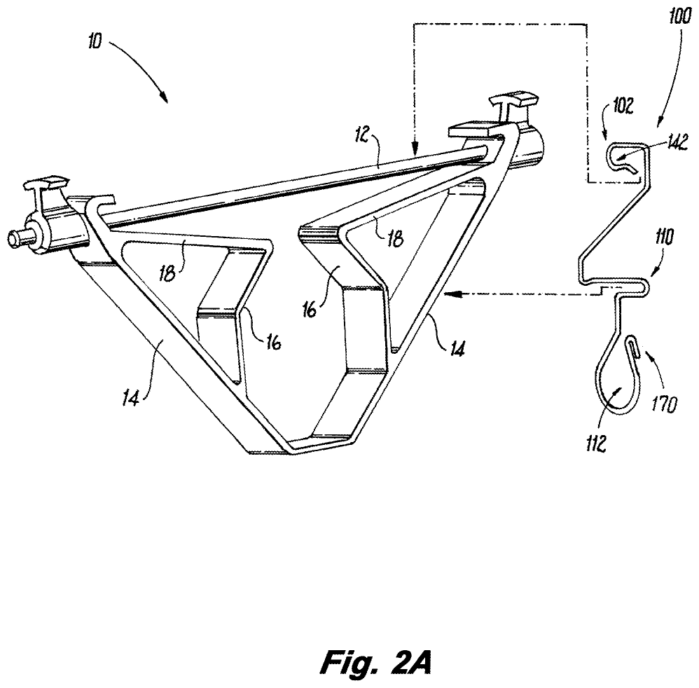

A wire or cable hanger 100 according to an exemplary embodiment of the present disclosure is shown in FIG. 2A-2C next to a frame or bracket 10 such as that described above with respect to FIG. 1. Hanger 100 is dimensioned and configured to be attached to bracket 10 so that cables and wires 30 passing bracket 10 can be adequately supported. Hanger 100 is formed from a single segment of wire. The wire may have a substantially circular cross section, although other cross-sectional shapes including square, rectangular, octagonal, etc. are also contemplated. Hanger 100 includes a proximal end 102 which may be referred to herein as proximal end section or hook end section 102. Proximal end section 102 includes a hook clip opening 142 dimensioned to receive crossbolt or cross member 12 of bracket 10. Hanger 100 also includes a distal end 170 which may be referred to herein as distal end section or cable loop end section 170. Hanger 100 also includes a clip-like section 110 formed between proximal end section 102 and distal end section 170. The clip-like section 110 of hanger 100 clips to V-shaped portion 14 of bracket 10 and secures hanger 100 to bracket 10. The cable loop end section 170 thus extends from bracket 10 and includes a circular loop opening section or loop section 112 for holding and securing cabling and wiring 30 safely out of the way of any moving mechanisms and prevents the cabling and wiring from causing shadowing on the solar modules.

As shown in FIG. 2B, a user first positions proximal end section 102 next to crossbolt 12 and presses hanger 100 until cross member 12 is seated in the hook clip opening 142. The user then rotates hanger 100 down toward bracket 10 until clip-like section 110 engages V-shaped portion 14 of bracket 10 and clips onto V-shaped portion 14 securing the hanger 100 to frame 10. Cabling and wiring 30 can then be placed in loop section opening 112 as shown in FIGS. 2B, 2C and securely held while allowing the cabling and wiring 30 to have a certain degree of freedom of movement. A terminal end portion of distal end section 170 may be bent over providing a smooth rounded off surface 116 at the opening to circular loop opening 112 so that when wires or cables 30 are inserted into loop opening 112, the wires and cables 30 will not be damaged. Since the material forming hanger 100 is a spring-like material, end section 116 may be temporarily urged open in the “Z” direction (FIG. 2C) providing a larger opening for larger diameter wires and cables to be received in loop opening 112.

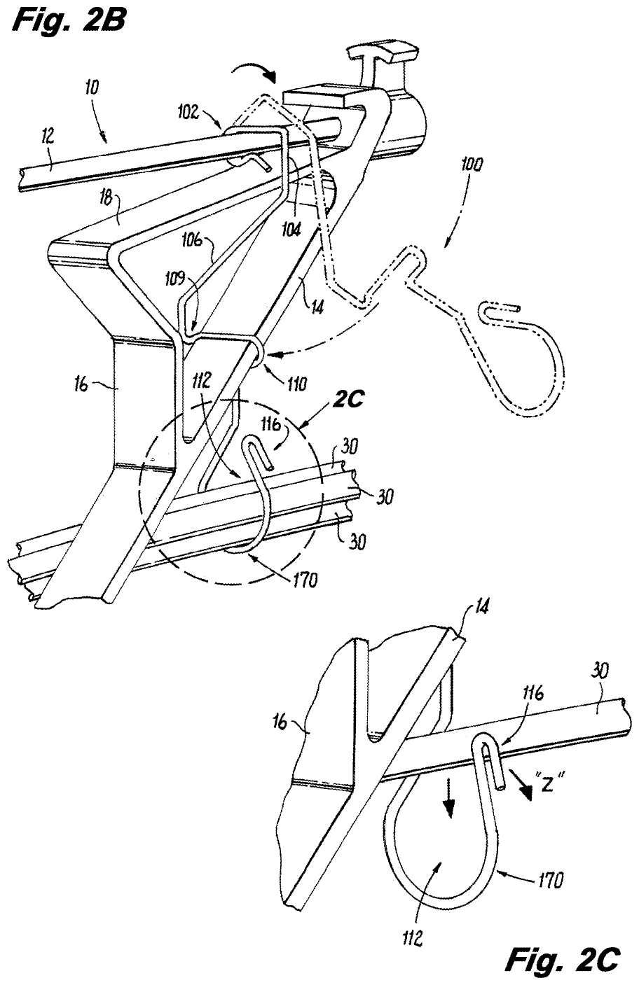

Hanger 100 according to an illustrative embodiment of the present disclosure is described in more detail by reference to FIGS. 3A-3D. Hanger 100 is formed from wire 114. Hook end section or proximal end section 102 includes a substantially circular bend 120 forming a hook clip opening 142. Hook clip opening 142 has a diameter “D” and is dimensioned to receive and be clipped to a cross bolt 12 forming a portion of a bracket 10 (see FIG. 3B). Depending on the particular design and configuration of the bracket 10, hook end section 102 may be configured differently. For example, hook end section 102 may assume a shape other than circular bend 120 and may be, for example, substantially square, rectangular, triangular, oblong, etc. to correspond to the shape of the cross bolt or cross member 12 of bracket 10. As shown in FIG. 3B, the width “W1” of the opening to hook clip opening 142 (e.g., between bend 125 of circular bend 120 and arm section 126) is less than diameter “D” thus ensuring a secure attachment when cross bolt or cross member 12 is received in hook clip opening 142. The portion of the wire 114 immediately prior to the terminal end 121 flairs outwardly as shown in FIG. 3B such that terminal end 121 may be easily pried outwardly (direction “Y”) to enlarge opening 131 making it easier for hook end section 102 to receive cross bolt 12. A portion of wire 114 immediately prior to the terminal end 121 may be bent in a hook shape as shown by phantom lines in FIG. 3B, providing a smooth rounded edge 133 making it easier to slide hanger 100 onto cross bolt 12 at opening 131 and into hook clip opening 142 when being attached to frame 10. According to an illustrative embodiment, the width of opening 131 may be formed smaller than an anticipated diameter of cross bolt or cross member 12 such that even if cross bolt 12 should somehow become disengaged from hook clip opening 142, hanger 100 will still remained attached to cross bolt 12. Hook end section 102 extends to arm section 126 which then forms a right-angle bend 128 to return arm section 104.

Referring to FIG. 3C, arm section 104 then bends at an obtuse angle (31 at section 132 to diagonal arm extension 106. Wire 114 then bends at an obtuse angle 32 to arm section 108 at clip-like section 110. According to an illustrative embodiment of the present disclosure, obtuse angles (31 and (32 are substantially the same. Of course, it will be appreciated the values of these angles as well as the length of each of the arm sections may vary depending on a size and shape of the particular frame 10 to which the hanger 100 is to be attached. Arm section 108 then bends at a substantially right angle to arm section 143 and includes an outwardly bending clip section formed by elbows 109 and 111. Arm section 143 then includes a substantially 180-degree U-shaped bend at section 113 to arm section 145. The gap 144 formed between arm section 143 and arm section 145 has a width “W2” dimensioned to receive a portion of V-shaped frame 14 of bracket 10. A length of arm section 143 is selected such that a lower edge portion 15 of the V-shaped frame 14 can be fully received in gap 144 and locked in position by outwardly bending clip section 109. For example, the portion of the V-shaped frame 14 to which the hanger 100 is to be attached is substantially rectangular in cross-section as shown in FIG. 3C. The width “W2” of gap 144 is slightly wider than a thickness of this portion of the V-shaped frame 14 such that the V-shaped frame 14 slides into opening 144. The length “X” of arm section 143 is dimensioned to receive the V-shaped frame 14. That is, as clip-like section 110 of hanger 100 is being pressed onto the V-shaped frame 14 and the V-shaped frame 14 is being received in gap 144, when the lower edge portion 15 of V-shaped frame passes clip section 109 the V-shaped frame 14 will snap into the position 111 shown in FIG. 3C. The hanger 100 thus has two secure points of attachment to bracket 10 having been effectively hooked and clipped to the bracket 10. Of course, these dimensions and shapes may vary depending on the shape and dimensions of the portion of the bracket 10 to which the hanger is to be attached.

As shown in FIG. 3D, arm section 145 makes a substantially right-angle bend at elbow 147 to arm portion 149 and finally to cable loop section 170 which includes loop section 112 formed by loop 137 of wire 114. As shown, loop section 112 includes an opening 127. Loop section 112 has a diameter D2 suitable for retaining one or more cables and wires 30 and may generally be in the 1-8 inch range or larger. Although loop section 112 is depicted as generally circular in shape, it will be appreciated other shapes including, square, rectangular, oval, triangular, etc. may be utilized. The portion of the wire 114 just prior to terminal end 123 may include a U-shaped bend providing a smooth rounded surface 116 at opening 127 so that when cables 30 are pressed through the opening 127 and received in loop section 112, the cables 30 are not nicked or otherwise damaged. The hook 117 formed at the end of loop 137 (FIG. 3A) may be hooked to arm portion 149 or loop 137 to form a closed loop further securing the wires and cables 30 within the loop 137.

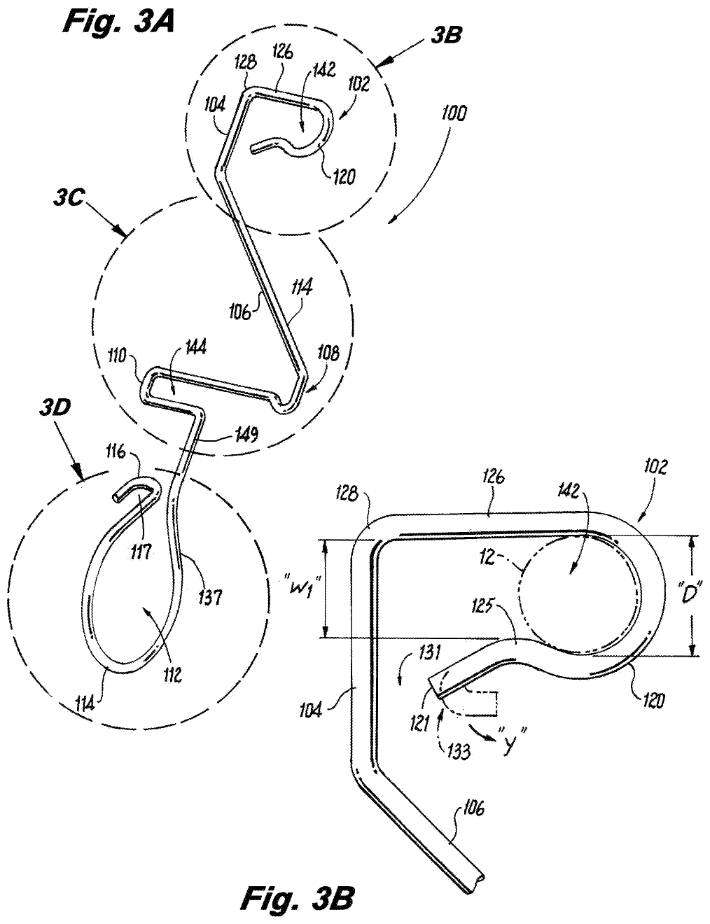

As depicted in FIG. 4, assuming the portions of the hanger 100 from proximal end section 102 to arm portion 149 are substantially in the same plane as the paper (e.g., the X-Y plane), cable retaining loop 137 extends substantially perpendicularly out of the paper in the Z-direction. Of course, this particular orientation may be reconfigured depending on a desired configuration of loop section 112. That is, loop 137 may be formed in the X-Y plane as the rest of hanger 100 or in any other orientation suitable for a particular application. This may be accomplished during manufacture of hanger 100 or by the end user by manually manipulating the hanger 100 into the desired orientation.

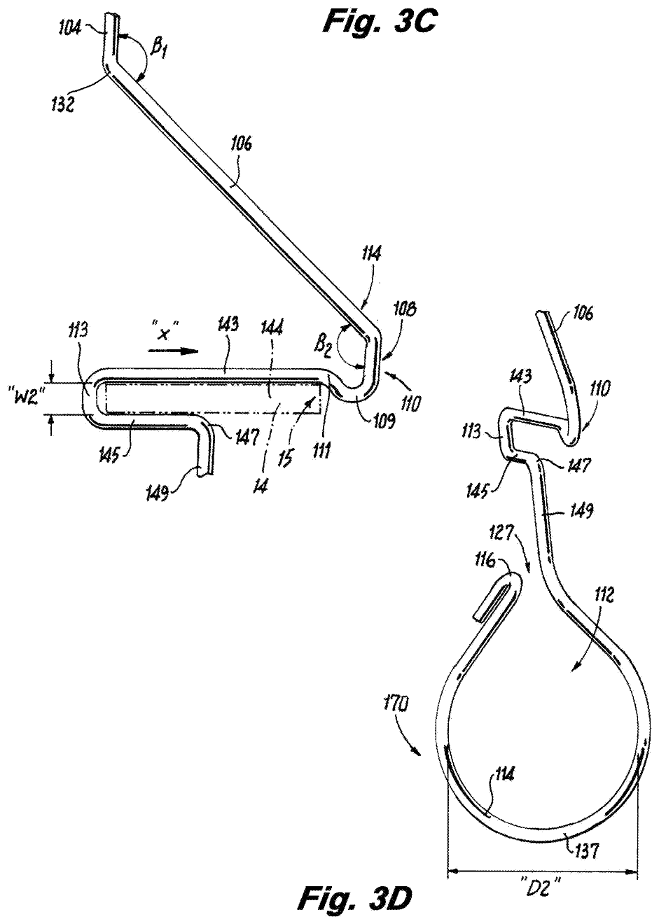

A portion of a cable hanger 100 according to another illustrative embodiment of the present disclosure is depicted in FIG. 5 and is referred to generally as hanger 200. Hanger 200 is substantially similar to hanger 100 but includes a variation of hook end section 102. According to this embodiment, hook end section 202 is substantially “reversed” from hook end section 102. That is, instead of hooking back “in” towards the remainder of hanger 200, hook end section 202 extends “out” from the remainder of hanger 200 from diagonal arm extension 106 and includes a substantially circular bend 220 between arm 226 and bend 225 to form a hook clip opening 242. A diameter “D” of hook clip opening 242 is dimensioned to receive and be clipped to the cross bolt 12 as seen in FIGS. 1 and 2A forming a portion of the frame 10. As described above with respect to hanger 100, depending on the particular design and configuration of the frame 10, hook end section 202 may be configured differently. For example, if cross bolt 12 has a cross section other than circular, hook end section 202 may assume a shape other than circular bend 220 and may be, for example, substantially square, rectangular, triangular, oblong, etc. in cross section. The hook clip opening 242 (e.g., between arm 226 and bend 225) is dimensioned such that the width “W” of the opening to hook clip opening 242 is less than diameter “D” thus ensuring a secure connection when hook clip opening 242 is clipped to cross bolt 12. The terminal end 221 portion of the cable 214 immediately prior to the terminal end 221 flairs outwardly as shown. This portion of cable 214 may also be bent in a hook shape as shown by phantom lines, providing a smooth rounded edge 233.

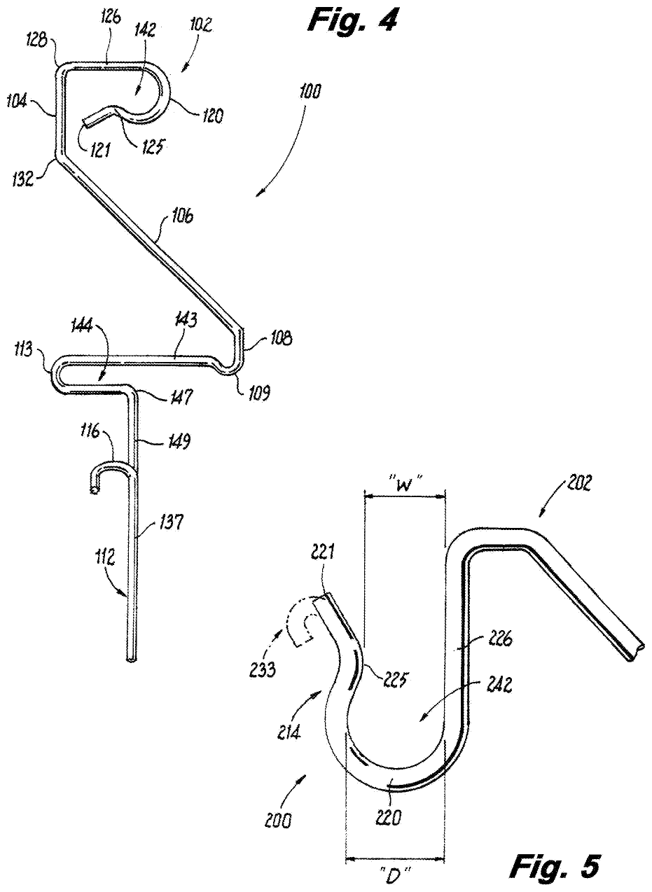

A portion of a cable hanger according to another illustrative embodiment of the present disclosure is depicted in FIG. 6. According to this embodiment, hanger 300 is substantially similar to hangers 100, 200 described above but includes a modified cable loop having end section 302 and end section 370. As shown, the portion of the wire 314 forming loop opening 312 is formed in a substantially square or rectangular shape. According to this illustrative embodiment, a coating 337 is provided on at least the portions of the hanger 300 that come into contact with wires and cables inserted into loop opening 312. Depending on a particular application, coating 337 may be an electrical insulator and/or may provide a higher coefficient of friction than the material forming the hanger itself. This allows the electrical wires and cables 30 being held in loop opening 312 to be electrically isolated from the hanger 300 and any structure upon which the hanger 300 is mounted. Providing a material with a higher coefficient of friction provides a surer grip to hold the wires and cables 30 in position. Examples of suitable coatings may include rubber or rubber like materials, plastics, varnish, etc. Coating 337 may be applied to hanger 300 in any suitable manner including, for example, by brush, spray or dipping, etc. Of course, any of the embodiments described herein may have the coating 337 applied to all of the hanger or only the portion of the hanger that will contact cables or wires 30 being held by the hanger.

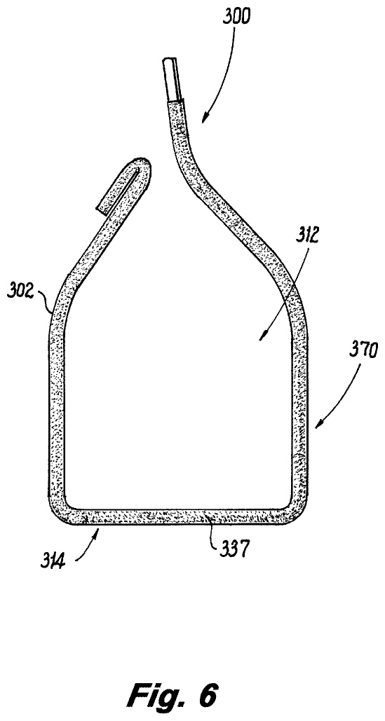

A wire or cable hanger according to another exemplary embodiment of the present disclosure is shown in FIGS. 7-9B and is referred to herein as hanger 400. Hanger 400 is dimensioned and configured to be attached to a bracket similar to bracket 10 (see FIG. 1) so that cables and wires 30 or other electrical components passing bracket 10 can be adequately supported. Hanger 400 is formed from a single segment of wire. The wire may have a substantially circular cross section, although other cross-sectional shapes including square, rectangular, octagonal, etc. are also contemplated. Hanger 400 includes a proximal end 402 which may be referred to herein as proximal end section or hook end section 402. Proximal end section 402 includes a hook clip opening 442 dimensioned to receive crossbolt or cross member 12 as seen in FIGS. 1 and 2A of bracket 10. Hanger 400 also includes a distal end 470 which may be referred to herein as distal end section or cable loop end section 470. Hanger 400 also includes a clip-like section 410 formed between proximal end section 402 and distal end section 470. The clip-like section 410 of hanger 400 clips to and rests in V-shaped portion 14 as shown in FIGS. 1 and 2A of bracket 10 and helps secure hanger 400 to bracket 10. The cable loop end section 470 thus extends from bracket 10 and includes a circular loop opening section or loop section 412 for holding and securing cabling and wiring 30 safely out of the way of any moving mechanisms and prevents the cabling and wiring from causing shadowing on the solar modules.

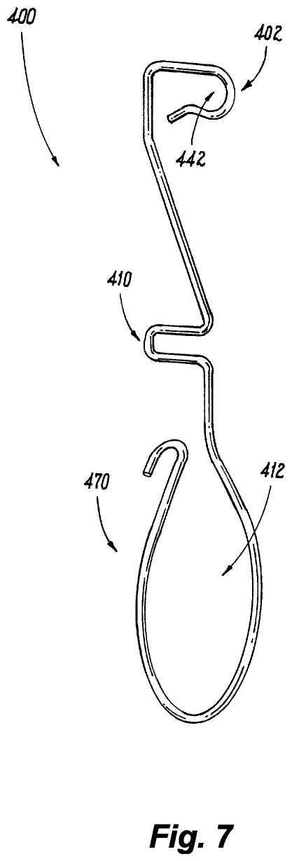

Hanger 400 according to an illustrative embodiment of the present disclosure is described in more detail by reference to FIGS. 8A-8D. Hanger 400 is formed from wire 414. Hook end section or proximal end section 402 includes a substantially circular bend 420 forming a hook clip opening 442. Hook clip opening 442 has a diameter “D” and is dimensioned to receive and be clipped to a cross bolt 12 forming a portion of a bracket 10 (see also FIG. 8B). Depending on the particular design and configuration of the bracket 10, hook end section 402 may be configured differently. For example, hook end section 402 may assume a shape other than circular bend 420 and may be, for example, substantially square, rectangular, triangular, oblong, etc. to correspond to the shape of the cross bolt or cross member 12 of bracket 10 to which it will be attached. As shown in FIG. 8B, the width “W1” of the opening to hook clip opening 442 (e.g., between bend 425 of circular bend 420 and arm section 426) is less than diameter “D” thus ensuring a secure attachment when cross bolt or cross member 12 is received in hook clip opening 442. The portion of the wire 414 immediately prior to the terminal end 421 may flair outwardly as shown in FIG. 8B such that terminal end 421 may be more easily pried outwardly (direction “Y”) to enlarge opening 431 making it easier for hook end section 402 to receive cross bolt 12. A portion of wire 414 immediately prior to the terminal end 421 may be bent in a hook shape as shown by phantom lines in FIG. 8B, providing a smooth rounded edge 433 making it easier to slide hanger 400 onto cross bolt 12 at opening 431 and into hook clip opening 442 when being attached to frame 10. According to an illustrative embodiment, the width of opening 431 may be formed smaller than an anticipated diameter of cross bolt or cross member 12 such that even if cross bolt 12 should somehow become disengaged from hook clip opening 442, hanger 400 will still remained attached to cross bolt 12.

Hook end section 402 extends to arm section 426 which then forms a right-angle bend 428 to return arm section 404 and then bends at an obtuse angle (31 at section 432 to diagonal arm extension 406 (FIG. 8C). Wire 414 then bends at an obtuse angle 32 to arm section 408. According to an illustrative embodiment of the present disclosure, obtuse angles (31 and (32 are substantially the same. Of course, it will be appreciated the values of these angles as well as the length of each of the arm sections 404, 406 and 408 may vary depending on a size and shape of the particular frame to which the hanger 100 is to be attached. Arm section 408 then bends at a substantially right angle to arm section 443. Arm section 443 then includes a substantially U-shaped bend at section 413 to arm section 445. The gap 444 formed between arm section 443 and arm section 445 has a width “W2” dimensioned to receive a portion of frame 14 of bracket 10. A length of arm sections 443 and 445 may be selected such that a lower edge portion 15 of the frame 14 can be fully received in gap or opening 444 or, as depicted in FIG. 8C, such that only a portion of the frame 14 is received in gap or opening 444. For example, the portion of the frame 14 to which the hanger 400 is to be attached is substantially rectangular in cross-section as shown in FIG. 8C. The width “W2” of gap 444 may be slightly wider than a thickness of this portion of the frame 14 such that the frame 14 slides into opening 444. Depending on a particular application, the length “X” of one or both of arm sections 443 and 445 may be dimensioned to extend up to or beyond the bottom 15 of the frame 14. According to another illustrative embodiment, the width “W2” of gap 444 may be slightly narrower than a thickness of this portion of the frame 14 such that as clip-like section 410 of hanger 400 is being pressed onto the frame 14 the clip-like section 410 will provide a compression fit to the frame 14. The hanger 400 thus has two secure points of attachment to bracket 10 having been effectively hooked and clipped to the bracket 10. Of course, these dimensions and shapes may vary depending on the shape and dimensions of the portion of the bracket 10 to which the hanger is to be attached.

As shown in FIG. 8D, arm section 445 makes a substantially right-angle bend at elbow 447 to arm portion 449 and finally to cable loop section 470 which includes loop section 412 formed by cable retaining loop 437 of wire 414. As shown, loop section 412 includes an opening 427. Loop section 412 has a diameter D2 suitable for retaining one or more cables and wires 30 and may generally be in the 1-8 inch range or larger. Although loop section 412 is depicted as generally circular in shape, it will be appreciated other shapes including, square, rectangular, oval, triangular, etc. may be utilized. The portion of the wire 414 just prior to terminal end 423 may include a U-shaped bend providing a smooth rounded surface 416 at opening 427 so that when cables are pressed through the opening 427 and received in loop section 412, the cables are not nicked or otherwise damaged. The U-shaped bend formed at the end of loop 437 may be hooked to arm portion 449 or loop 437 to form a closed loop further securing the wires and cables 30 within the loop 437.

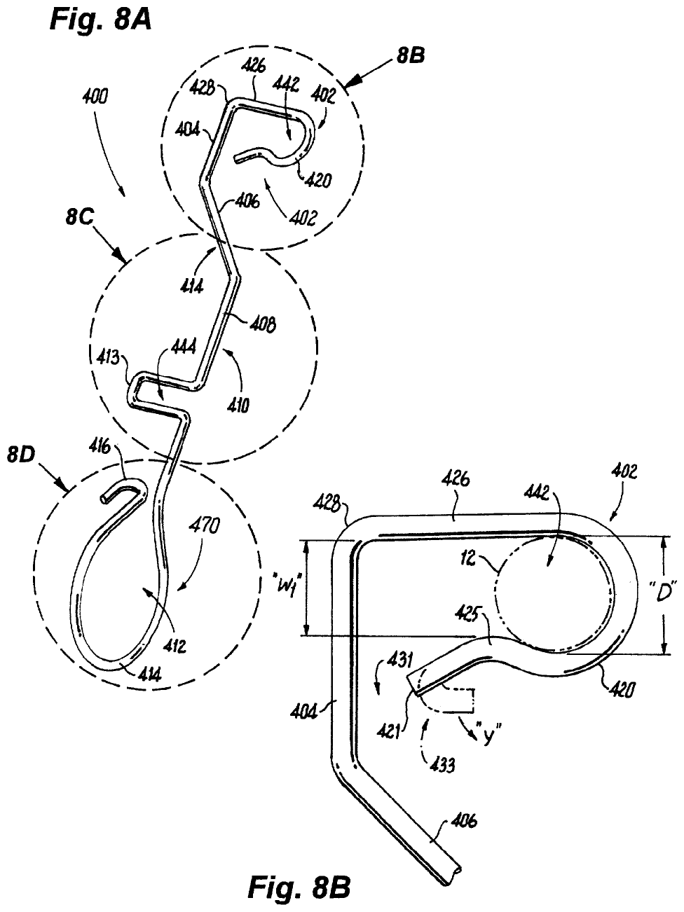

As depicted in FIG. 9A, assuming the portions of the hanger 400 from proximal end section 402 to arm portion 449 are substantially in the same plane as the paper (e.g., the X-Y plane), cable retaining loop 437 extends substantially perpendicularly out of the paper in the Z-direction. Of course, this particular orientation may be reconfigured depending on a desired configuration of loop section 412. That is, cable retaining loop 437 may be formed in the X-Y plane as the rest of hanger 400 or in any other orientation suitable for a particular application. This may be accomplished during manufacture of hanger 400 or by the end user by manually manipulating the hanger 400 into the desired orientation.

Hanger 400 can be attached to bracket 10 as shown in FIGS. 1, 2A and 2B in a manner similar to hanger 100 as described above with respect to FIG. 2B. As shown in FIG. 9B, the user first positions proximal end section 402 next to crossbolt 12 and presses hanger 400 until cross member 12 is seated in the hook clip opening 442. The user then rotates hanger 400 down toward bracket 10 until gap or opening 444 of clip-like section 410 engages V-shaped portion 14 of bracket 10 and secures the hanger 400 to frame 10. Cabling and wiring can then be placed in loop opening 412 and securely held while allowing the cabling and wiring to have a certain degree of freedom of movement. As noted above, terminal end portion of distal end section 470 may be bent over providing a smooth rounded off surface 416 at the opening to circular loop opening 412 so that when wires or cables are inserted into loop opening 412, the wires and cable will not be damaged. Since the material forming hanger 400 is a spring-like material, end section 416 may be temporarily urged open (in the “Z” direction similar to that described above with respect to the embodiment depicted in FIG. 2C) providing a larger opening for larger diameter wires and cables to be received in loop opening 412.

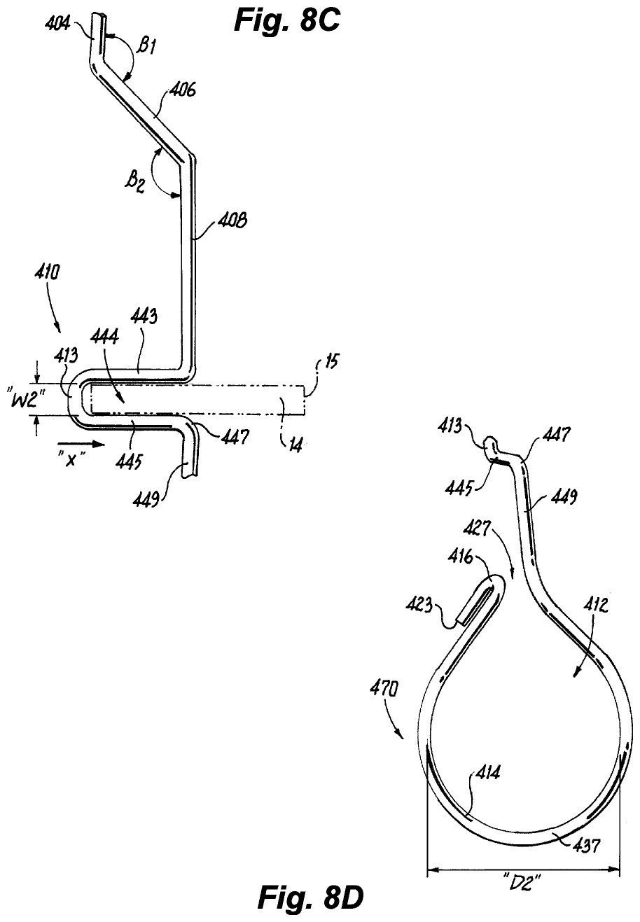

Similar to that described above with respect to FIG. 6, the cable loop end section 470 may be formed in any desired shape. In addition, as depicted in FIG. 10, a coating 403 may be provided on at least the portions of the hanger 400 that come into contact with wires and cables inserted into loop opening 412. Depending on a particular application, coating 403 may be an electrical insulator and/or may provide a higher coefficient of friction than the material forming the hanger 400 itself. This allows the electrical wires and cables being held in loop opening 412 to be electrically isolated from the hanger 400 and any structure upon which the hanger 400 is mounted. Providing a material with a higher coefficient of friction provides a surer grip to hold the wires and cables in position. Examples of suitable coatings may include rubber or rubber like materials, plastics, varnish, etc. Coating 403 may be applied to hanger 400 in any suitable manner including, for example, by brush, spray or dipping, etc. Of course, any of the embodiments described herein may have the coating 403 applied to all of the hanger or only the portion of the hanger that will contact cables or wires being held by the hanger.

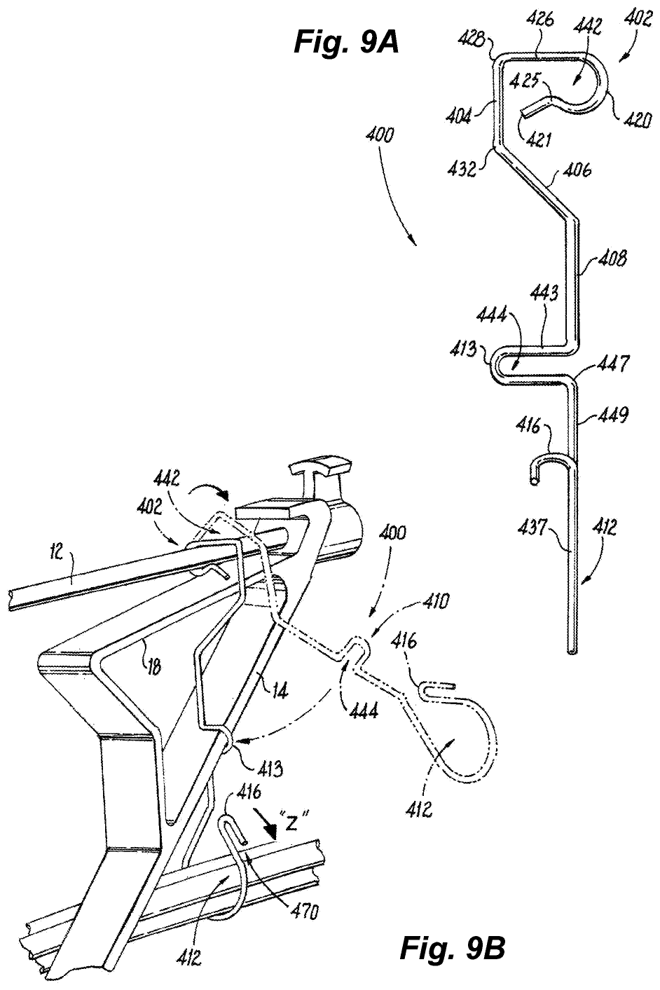

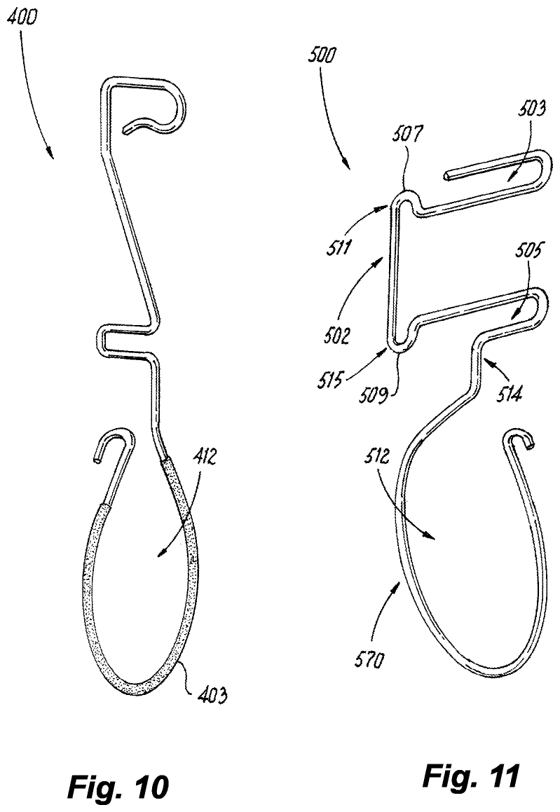

A wire or cable hanger according to another exemplary embodiment of the present disclosure is shown in FIG. 11 and is referred to herein as hanger 500. Hanger 500 is dimensioned and configured to be attached to a bracket similar to bracket 10 (see FIG. 1) so that cables and wires passing bracket 10 can be adequately supported. Hanger 500 is formed from a single segment of wire 514. The wire 514 may have a substantially circular cross section, although other cross-sectional shapes including square, rectangular, octagonal, etc. are also contemplated. Hanger 500 includes a proximal end 502 which may be referred to herein as proximal end section or clip end section 502. Clip end section 502 includes bracket receiving sections 503 and 505 and clip-like sections 511 and 515 as shown in FIG. 12B. The clip end section 502 of hanger 500 clips to V-shaped bracket support portions 18 and 14 of bracket 10 (e.g., see FIG. 1) and secures hanger 500 to bracket 10. Hanger 500 also includes a distal end 570 which may be referred to herein as distal end section or cable loop end section 570 having a loop section 512. When hanger 500 is secured to bracket 10, loop section 512 extends from the bracket 10 for holding and securing cabling and wiring safely out of the way of any moving mechanisms and prevents the cabling and wiring from causing shadowing on the solar modules.

Hanger 500 according to an illustrative embodiment of the present disclosure is described in more detail by reference to FIGS. 12A-12C. Clip end section 502 includes a series of bends dimensioned and positioned for receiving and attaching to a frame or bracket such as bracket 10 depicted in FIGS. 1 and 2A. For example, bracket receiving section 503 is dimensioned for receiving bracket support portion 18 of bracket 10. Bracket receiving section 503 includes arm 504 having a length L1, U-shaped bend 506 having an inner width W1 and return arm 508 having a length L2. Return arm 508 extends to portions 507, 510 which form a substantially V-shaped clip-like section 511. For example, at least a portion of the V-shaped clip-like section 511 extends into an area longitudinally below the bracket receiving section 503. Depending on a particular application, the width W1 of the bracket receiving section 503 may be smaller than or similar to the thickness of bracket support 18, providing a compression fit of bracket support 18 to bracket receiving section 503. Alternatively, the width W1 of the bracket receiving section 503 may be greater than the thickness of bracket support 18. The length L2 of return arm 508 is sufficiently long enough such that bracket receiving section 503 can receive the bracket support 18, as shown in FIG. 12B. The length L1 of arm 504 may be the same or shorter than the length L2 of return arm 508. When bracket support 18 is positioned within bracket receiving section 503, clip-like section 511 effectively clips and holds bracket support 18 within bracket receiving section 503. As noted above, portions 507, 510 of clip-like section 511 extend out into the area longitudinally below bracket receiving section 503 aiding in preventing bracket support 18 from being easily dislodged from within bracket receiving section 503.

Portion 507 of V-shaped clip-like section 511 then extends to cross arm 513 and to substantially V-shaped clip like section 515 and to bracket receiving section 505. It will be appreciated from the following detailed description that the length L4 of cross arm 513 may vary depending, for example, on the gap between support portions 18 and 14 as shown in FIGS. 1 and 2A of bracket 10. Bracket receiving section 505 is dimensioned for receiving bracket support portion 14 of bracket 10. Bracket receiving section 505 includes arm 520 having a length L5, U-shaped bend 518 having an inner width W2 and return arm 516 having a length L3. Return arm 516 extends to portions 544, 509 which form the substantially V-shaped clip-like section 515. For example, at least a portion of the V-shaped clip-like section 515 extends into an area longitudinally below the bracket receiving section 505. Depending on a particular application, the width W2 of the bracket receiving section 505 may be smaller than or similar to the thickness of bracket support 14, providing a compression fit of bracket support 14 to bracket receiving section 505. Alternatively, the width W2 of the bracket receiving section 505 may be greater than the thickness of bracket support 14. The length L3 of return arm 516 is sufficiently long enough such that bracket receiving section 505 can receive the bracket support 14, as shown in FIG. 12B. The length L5 of arm 520 may be the same or shorter than the length L3 of return arm 516. When bracket support 14 is positioned within bracket receiving section 505, clip-like section 515 effectively clips and holds bracket support 14 within bracket receiving section 505. As noted above, portions 509, 544 of clip-like section 515 extend out into the area longitudinally below bracket receiving section 505 aiding in preventing bracket support 14 from being easily dislodged from within bracket receiving section 505. The hanger 500 thus has two secure points of attachment to bracket 10 having been effectively clipped to bracket 10 at two points. Of course, the dimensions and shapes of hanger 500 may vary depending on the shape and dimensions of the portion of the bracket 10 to which the hanger is to be attached.

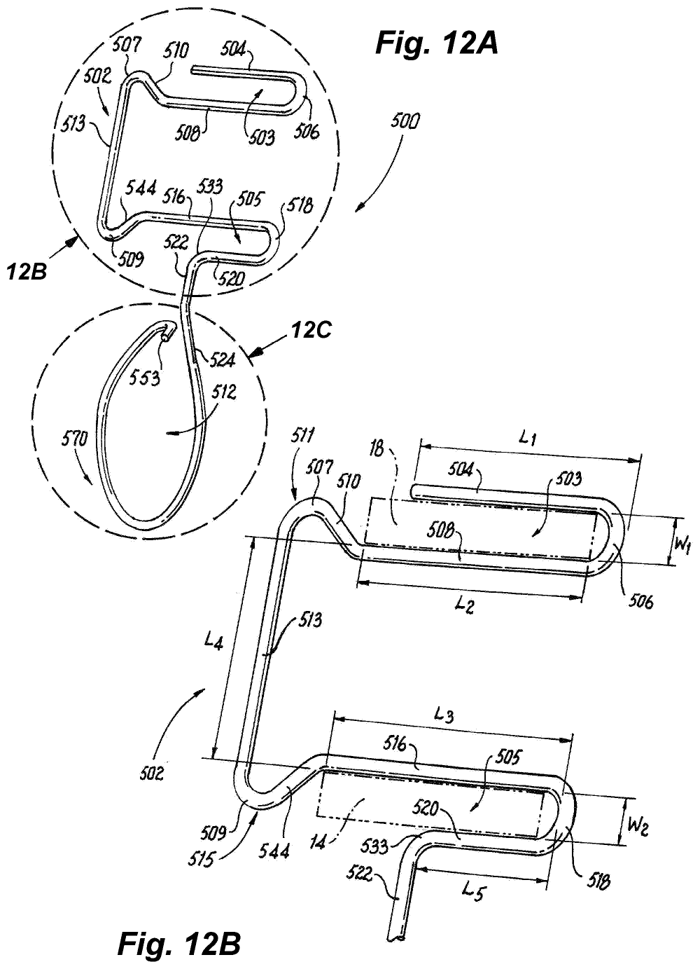

As shown in FIGS. 12C and 13, arm section 520 makes a substantially right-angle bend at elbow 533 to arm extension 522 and finally to cable loop section 570 which includes loop section 512 formed by loop 524 of wire 514. As shown, loop section 512 includes an opening 527. Loop section 512 has a diameter D suitable for retaining one or more cables and wires 30 and may generally be in the 1-8 inch range or larger. Although loop section 512 is depicted as generally circular in shape, it will be appreciated other shapes including, square, rectangular, oval, triangular, etc. may be utilized. The portion of the wire 514 just prior to terminal end 553 may include a U-shaped bend providing a smooth rounded surface 555 at opening 527 so that when cables are pressed through the opening 527 and received in loop section 512, the cables are not nicked or otherwise damaged. The U-shaped bend provided just prior to terminal end 553 also forms a hook that may be hooked to arm extension 522 or loop 524 to form a closed loop further securing the wires and cables 30 within the loop section 512.

As depicted in FIG. 13, assuming the portions of the hanger 500 from proximal end section 502 to arm portion 522 are substantially in the same plane as the paper (e.g., the X-Y plane), cable loop section 570 extends substantially perpendicularly out of the paper in the Z-direction. Of course, this particular orientation may be reconfigured depending on a desired configuration of loop section 570. That is, loop section 570 may be formed in the X-Y plane as the rest of hanger 500 or in any other orientation suitable for a particular application. This may be accomplished during manufacture of hanger 500 or by the end user by manually manipulating the hanger 500 into the desired orientation.

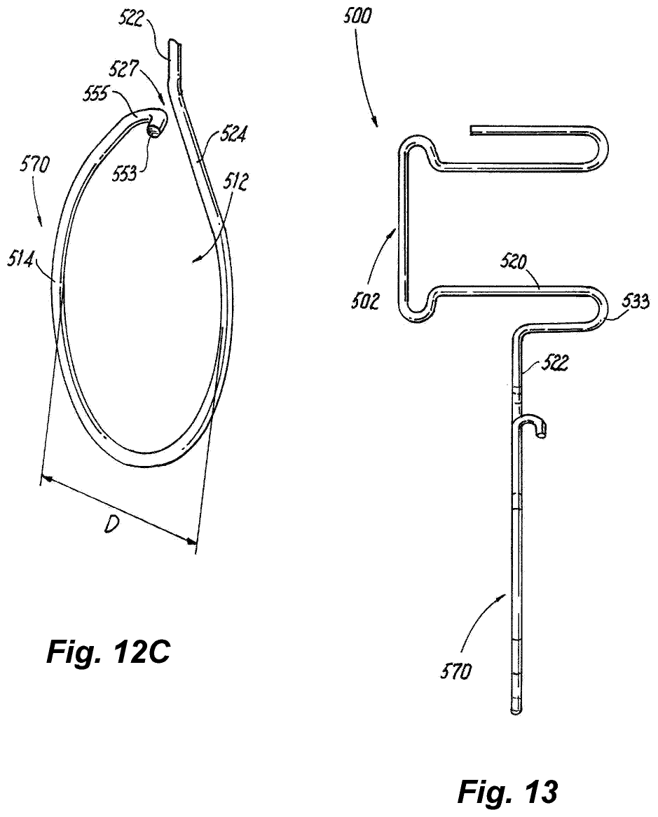

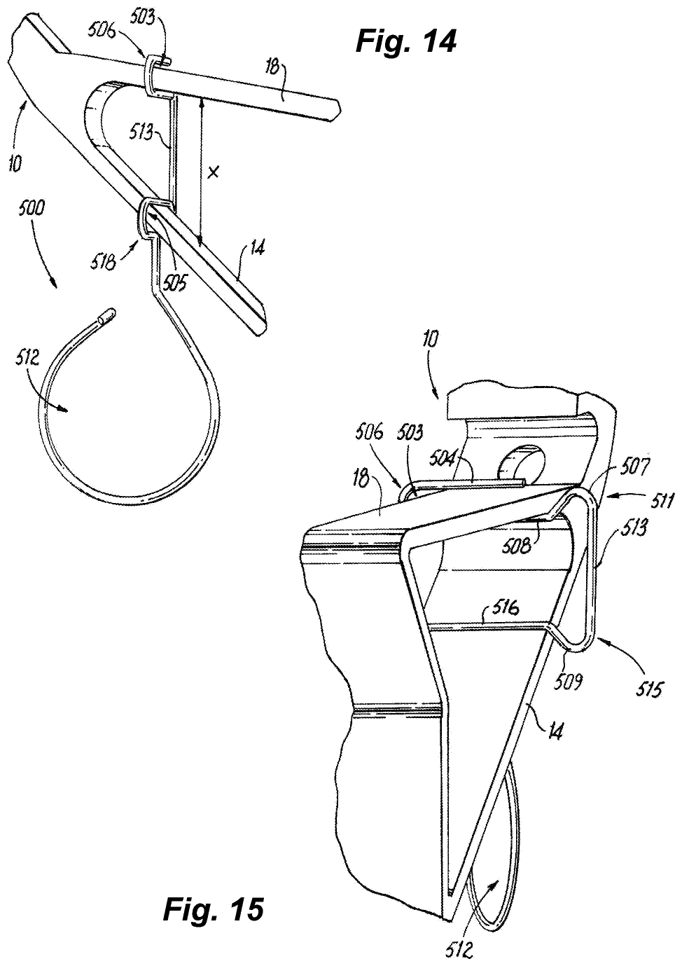

Referring to FIGS. 14 and 15, hanger 500 may be attached to frame or bracket 10 by first positioning bracket receiving sections 503, 505 over bracket sections 18, 14, respectively. Cross arm 513 is then urged downward until clip-like sections 515, 511 engage and clip onto the bottom of bracket sections 14, 18, respectively, as shown.

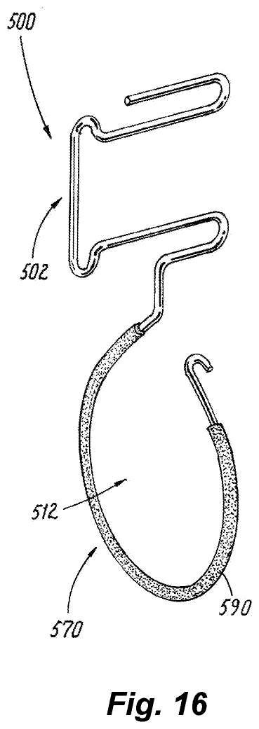

As described in above embodiments, the cable loop opening 512 may be formed in any desired shape. In addition, as depicted in FIG. 16, a coating 590 may be provided on at least the portions of the hanger 500 that come into contact with wires and cables inserted into loop opening 512. Depending on a particular application, coating 590 may be an electrical insulator and/or may provide a higher coefficient of friction than the material forming the hanger 500 itself. This allows the electrical wires and cables being held in loop opening 512 to be electrically isolated from the hanger 500 and any structure upon which the hanger 500 is mounted. Providing a material with a higher coefficient of friction provides a surer grip to hold the wires and cables in position. Examples of suitable coatings may include rubber or rubber like materials, plastics, varnish, etc. Coating 590 may be applied to hanger 500 in any suitable manner including, for example, by brush, spray or dipping, etc. Of course, any of the embodiments described herein may have the coating 590 applied to all of the hanger or only the portion of the hanger that will contact cables or wires being held by the hanger.

While the present disclosure refers to the use of a single segment of wire in the above-described embodiments, it will be appreciated the single segment might be multiple segments which are welded, soldered or otherwise joined to form the single segment of wire used to make the described cable hangers.

As shown throughout the drawings, like reference numerals designate like or corresponding parts. While illustrative embodiments of the present disclosure have been described and illustrated above, it should be understood that these are exemplary of the disclosure and are not to be considered as limiting. Additions, deletions, substitutions, and other modifications can be made without departing from the spirit or scope of the present disclosure. Accordingly, the present disclosure is not to be considered as limited by the foregoing description.

What is claimed is:

1. A hanger for securing electrical cabling to a structure, the hanger comprising:
a cable holding portion provided at a distal end of the hanger for holding one or more cables to be secured;
a hook-like portion provided at a proximal end portion of the hanger for securing to the structure; and
a locking clip-like portion provided intermediate of the cable holding portion and the hook-like portion for clipping the hanger to and securing the hanger to the structure.

2. An electrical cable hanger for securing a electrical cable to a structure, the electrical cable hanger comprising:
a segment of wire comprising a proximal end and a distal end;
a cable holding portion provided at the distal end of the segment of wire for holding one or more cables to be secured; and
at least one locking clip-like portion provided between the proximal end and the distal end of the segment of wire for clipping the hanger to and securing the hanger to the structure.

3. The electrical cable hanger as recited in claim 2, wherein the at least one locking clip-like portion comprises a space for receiving a portion of the structure to which the cable hanger is to be attached.

4. The electrical cable hanger as recited in claim 3, wherein the space comprises a substantially U-shaped bend in the segment of wire.

5. The electrical cable hanger as recited in claim 4, further comprising a section of wire extending into an area longitudinally below the U-shaped bend.

6. The electrical cable hanger as recited in claim 5, wherein the section of wire comprises a substantially V-shaped bend in the segment of wire.

7. The electrical cable hanger as recited in claim 2, wherein the at least one locking clip-like portion comprises two locking clip-like portions.

8. The electrical cable hanger as recited in claim 2, wherein each of the locking clip-like portions comprise a space for receiving separate portions of the structure to which the cable hanger is to be attached.

9. The electrical cable hanger as recited in claim 8, wherein each space comprises a substantially U-shaped bend in the segment of wire.

10. The electrical cable hanger as recited in claim 9, further comprising sections of wire extending into areas longitudinally below the U-shaped bends.

11. The electrical cable hanger as recited in claim 10, wherein the sections of wire comprise substantially V-shaped bends in the segment of wire.

12. The electrical cable hanger as recited in claim 8, wherein a width of each of the locking clip-like portions has a width smaller than or similar to a thickness of the structure to which the cable hanger is to be attached.

13. The electrical cable hanger as recited in claim 12, wherein the locking clip-like portions provide a compression fit to the structure to which the cable hanger is to be attached.

14. The electrical cable hanger as recited in claim 2, wherein the segment of wire comprises spring steel.

15. An electrical cable management system comprising:
a segment of wire comprising,
a distal end portion configured as a cable carrier for holding one or more cables;
a proximal end portion comprising a clip-like portion configured to clip onto a first portion of a frame; and
an intermediate portion comprising a clip-like portion configured to clip onto a second portion of the frame.

16. The electrical cable management system as recited in claim 15, wherein the distal end portion comprises a loop.

17. The electrical cable management system as recited in claim 16, wherein the loop comprises an open loop.

18. The electrical cable management system as recited in claim 15, wherein the clip-like portions comprise spaces for receiving portions of a bracket to which the cable hanger is to be attached.

19. The electrical cable management system, as recited in claim 18, wherein the spaces comprise substantially U-shaped bend in the segment of wire.

20. The electrical cable hanger as recited in claim 18, wherein the segment of wire further comprises sections of wire extending into areas longitudinally below the U-shaped bends.
